(19) United States
(12) Patent Application Publication
(10) Pub. No.: US 2005/0091107 A1
(43) Pub. Date: Apr. 28, 2005

(54) Media player and access system and method and media player operating system architecture

(76) Inventor: Scott Blum, Jackson, WY (US)

Correspondence Address: LUCE, FORWARD, HAMILTON & SCRIPPS LLP, 11988 EL CAMINO REAL, SUITE 200, SAN DIEGO, CA, 92130, US

(21) Appl. No.: 10/845,680

(22) Filed: May 14, 2004

Related U.S. Application Data
(60) Provisional application No. 60/513,726, filed on Oct. 22, 2003.
(60) Provisional application No. 60/566,379, filed on Apr. 28, 2004.

(51) Int. Cl. G06F 17/60

(52) U.S. Cl. 705/14

(57) ABSTRACT

A computer operating system and media player are provided in which an integrated desktop environment is provided wherein a separate window is not necessary to operate the media player or perform other functionalities. In one embodiment, the media player controls are situated in a particular location on the desktop while the remainder of the desktop is available for internet, media player, e-commerce or other functionalities without opening separate windows. A cache memory management system also is provided in which free memory regions are used for the storage of data available for purchase or usage.

Priority is claimed to U.S. Provisional Application No. 60/513,726, filed Oct. 22, 2003, entitled, “Media Player And Access System And Method And Media Player Operating System Architecture” and U.S. Provisional Application No. 60/566,379, filed Apr. 28, 2004, entitled, “Media Player And Access System And Method And Media Player Operating System Architecture”, both of which are referred to and hereby incorporated herein by reference in their entireties.

### FIELD OF THE INVENTION

The present invention relates to a media player system and alternatively a computer operating system incorporating media player and e-commerce functionality.

### BACKGROUND OF THE INVENTION

Various music players and video players operating on personal computer systems are known. One example is the Windows Media Player available from Microsoft Corp. of Redmond, Wash. In operation, the Windows Media Player can be opened by various known alternatives, such as clicking on a toolbar icon, opening from a “Programs menu from the Windows operating system “Start area, or alternatively clicking on a desktop icon. Once opened, the Windows Media Player can be used to open and play videos or music files.

Other examples of conventional media players include Musicmatch Jukebox Basic available from Musicmatch of San Diego, Calif. or iTunes available from Apple Computer Inc. of Cupertino, Calif. By way of example, the Musicmatch Jukebox Basic can be installed on a personal computer by loading the software, such as by downloading from the Musicmatch.com website. This software can be opened by the various known techniques, such as such as clicking on a toolbar icon, opening from a “Programs menu, or clicking on a desktop icon. Once opened, the Musicmatch Jukebox Basic appears in a separate window from the computer desktop, and separate from other program windows. It can be used to open and play music files on a personal computer, and to perform other music related functionalities such as downloading music, burning CDs, playing downloaded music, playing a “radio or audio stream from a website server received via the internet, playing other streamed audio, playing tracks from a CD, managing a music file library, sending to a portable music player, managing a user's subscription account, obtaining information via the Internet on music, performers etc.

One problem with known media players is that they are not fully integrated with or skinned with an e-commerce engine or the operating system of the computer on which they are operating. In operation typical music players open into a separate window on a computer desktop. E-commerce functionality typically is limited to downloading music tracks leading to inefficiency or the need for multiple software program operation to allow users to shop for or purchase related or unrelated merchandise and services. If a user wants to listen to music, typically, a player window is opened and configured to play the music desired and then is operated in background if the user wishes to perform other functions on the computer.

Another shortcoming of known media players is that they do not have an automatic interactive facility with one or more servers, whereby personal preferences or other criteria are provided to push or automatically download desired content.

Accordingly, there is a need for a system to more seamlessly integrate media, entertainment, advertising and e-commerce to computer desktops and operating systems.

### SUMMARY OF THE INVENTION

The present invention alleviates to a great extent these and other disadvantages of known music or media players by providing a system and method in which a media player is integrated with an e-commerce system and/or the operating system. In one embodiment, the media player and e-commerce system are skinned with the operating system. In this description, “skinned will be understood to mean integrated with or operating together with. In one example, the media player and its e-commerce engine dictate numerous characteristics of the user interface of the operating system in order to provide a seamless media, entertainment and/or e-commerce experience for the user. In another example, the media player takes over all the portions of user's system, such as taking control over its look and feel, desktop and/or other functions of the user's system such as by incorporating operating system, browser, search, e-commerce, media playing and payment, and/or other capabilities. Among the capabilities controlled is a cache memory which occupies a portion or all of otherwise unused portions of the user's system hard drive or other memories and provides relatively instant access to content in it.

In the preferred embodiment, the media player of the present invention is integrated with the operating system desktop environment whereby a separate window is not necessary to operate the media player and the look and feel of the desktop environment is or can be controlled by or through the media player. For example, the media player controls can be situated in a particular location on the desktop, which will be referred to herein as a “toolbar or “media player location, and the computer display provided in other portions of the display screen not dedicated to the media player toolbar.

Likewise e-commerce and shopping capability is integrated with the media player. In this description, “media player will cover both the media playing functionalities, as well as other functionalities including without limitation, the cache memory management functionalities, e-commerce functionalities, no-click payment functionalities, advertising vehicle functionalities, search functionalities and so on.

The E-commerce functionality of the present invention provides, in one embodiment, expedited browsing and/or purchasing of goods or services. In one aspect, items related to or deemed by an e-commerce module to be related to a media being played or browsed via the media player are displayed for information purposes, or for purchase. For example, in this embodiment, content can be provided to the user system based on observed or indicated preferences. In another aspect, content, such as movies or music are available for viewing either on a rental or purchase basis for a fee, with payment managed by the media player system of the present invention.

In another embodiment of the e-commerce functionality, an advertising vehicle is provided in which the media player system establishes an Internet connection and sends a connection signal to a server system. The server system then provides content, optionally including advertising to the media player system for display at designated times, or upon a play operation by the user or interspersed in play or simultaneously with play. Alternatively, the server system can otherwise detect the media player system without the sending of a connection signal.

In another aspect of the present invention, if a user wishes to download media or otherwise stream a media file, that can be accomplished via the desktop rather than in a separate window or background if desired.

In an alternative embodiment of the present invention, a computer operating system is provided integrating the media player functionality as described herein. For example, the operating system provides integrated Internet access capability, media player capability and/or e-commerce capability. In another example, media or advertising content is cached either locally by the operating system for display as desired, or as set via parameter selection and control, or alternatively such content is cached on a remote system and provided to the user's system by pulling or pushing operations.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a diagrammatic illustration of an Internet commerce and media content system in accordance with the present invention;

FIG. 2 is a block diagram illustrating an example of a user system in accordance with the present invention;

FIG. 3 is a flowchart illustrating an example of installation processing steps for a media player application embodiment of the present invention;

FIG. 4 is an illustration of a user system desktop and a media player in accordance with the present invention;

FIG. 5 is an illustration of a radio function display in accordance with the present invention;

FIG. 6 is a diagrammatic illustration of a media player in accordance with the present invention;

FIG. 7 is a flowchart illustrating an example of an e-commerce function of a media player in accordance with the present invention;

FIG. 8 is an illustration of a user system desktop and a player in accordance with the present invention;

FIG. 9 is an illustration of a user system desktop and a player in accordance with the present invention;

FIG. 10 is a flowchart illustrating an example of operation of a player in accordance with the present invention;

FIG. 11 is a graphical depiction of a user system memory in accordance with the present invention;

FIG. 12 is a graphical depiction of a user system memory in accordance with the present invention;

FIG. 13 is an illustration of a user system desktop and a player in accordance with the present invention;

FIG. 14 is a flowchart illustrating an example of operation of a player in accordance with the present invention;

FIG. 15 is a flowchart illustrating an example of operation of a system in accordance with the present invention;

FIG. 16 is a flowchart illustrating an example of operation of a system in accordance with the present invention;

FIG. 17 is a diagrammatic illustration of a system in accordance with the present invention; and

FIG. 18 is a flowchart illustrating an example of operation of a system in accordance with the present invention.

### DETAILED DESCRIPTION OF THE INVENTION

In the following paragraphs, the present invention will be described in detail by way of example with reference to the accompanying drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects.

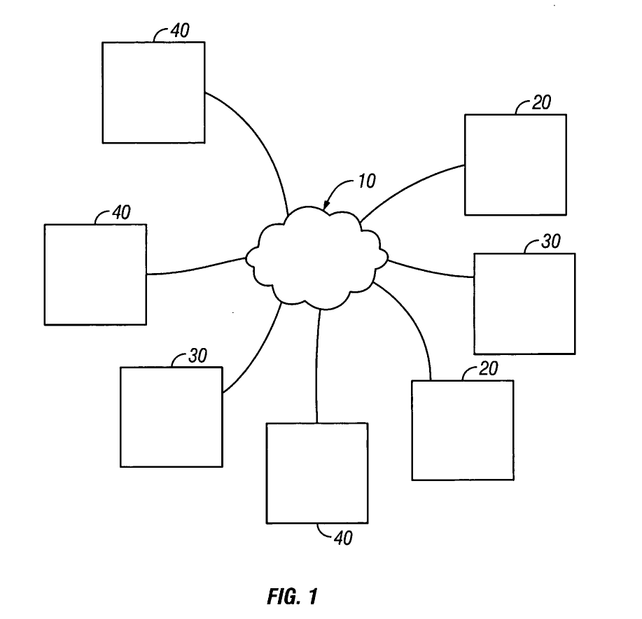

An entertainment or Internet commerce system is illustrated in FIG. 1, in which reference number 10 points to a representation of an electronic communications network (“ECN or “Internet ), such as the Internet. Media content providers are illustrated with reference number 20. In one embodiment, they are websites accessible to users. In another embodiment, they are content provider locations that can supply content to a user's system 40. For example, one or more content provider locations 20 optionally can “push media or other content in the form of electronic or digital data to one or more specified user systems 40, either on a schedule or at other desired times. In one example, desired times, may optionally correspond to low bandwidth usage times, such as when the content provider is inactive or when there is more Internet bandwidth availability (often lower cost), such as in early morning hours. In another example, content is pushed to the user systems 40 from one or more content provider systems 20 when the user system 40 logs on to a network announcing its presence. Alternatively, the operating system 40 or content player software of user systems 40 may include an agent module that pulls or otherwise orders, initiates, requests or signals availability for delivery of content immediately or at any other time. Such content provider locations or websites 20 are connected to the Internet for two way communication to and from the media content providers' respective systems 20. Internet commerce websites are illustrated with reference number 30. It should be noted that media content provider websites 20 optionally can provide any desired content, including e-commerce in addition to media content such as music data, video data, audiovisual data, information related thereto or any other type of data, in other words the functionality of Internet commerce websites. Likewise Internet commerce websites 30 can provide any desired content, including media content in addition to goods and services or any type of data, in other words, the functionality of content provider systems 20. Separate reference numerals 20, 30 are therefore provided only for purposes of illustrating different types of content providers, and are not necessarily mutually exclusive. Examples of Internet commerce websites 30 are websites offering goods and services for sale, information providers, such as on-line news services, directories, encyclopedias, travel service providers, other advertisers and so on. Examples of media content websites 20 are websites offering music or movies for streaming or download. Of course it is understood that such media content websites 20 and Internet commerce websites 30 can include one or more computer or server systems providing storage capacity storing database modules of rich media, such as for example, music, video or other entertainment information and data files, product information and prices, product information pages, customer information, order information etc. As used herein, “product refers to any type of product or service available for purchase, license or rental, including without limitation music, movies and other entertainment content or any other type of good or service. In terms of implementation hardware and software, Internet commerce websites 30 and media content 20 can comprise the requisite computing equipment and software for storage of electronic or optical data, receiving and transmitting signals via an ECN either wired or wireless.

The user systems 40 also preferably are capable of operating on the Internet, or on local networks, WANs or on a stand-alone basis. These systems can include any computing devices, such as computers (such as PCs, laptops, notebooks, PDAs etc.), telephone handsets, cellular phones, personal data assistants (PDAs) and so on. The term “user system is also used interchangeably herein with the term “user , “consumer , “appliance , “client or “client system. Also as understood herein, the term “PC is used to refer to any type of personal computer, including without limitation desktop, portable, laptop, notebook and PDA computers. It should be noted that user systems 40 of the present invention are referred to with reference numbers 40 and 1240 in this description.

These computing systems are operated via an operating system such as for example Windows available from Microsoft Corp. or any other operating system available such as Solaris from Sun Microsystems, PS/2 from IBM, the Macintosh operating system from Apple Computer Inc., or Linux etc. Alternatively, the operating system embodiment of the present invention can be used to operate one or more of the user systems 40.

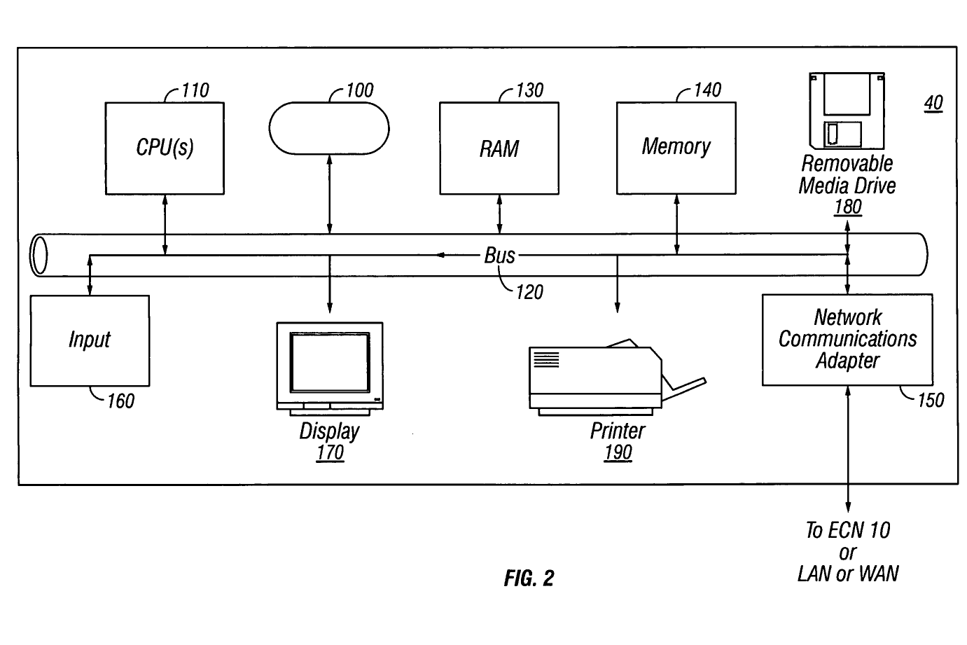

As illustrated in FIG. 2, a typical user system 40 includes a central processing unit 110 (CPU). The CPU 110 optionally is connected through a bus 120 to, among other things, volatile memory 130 (also called RAM or random access memory), non-volatile memory 140 (such as disk drive(s) or other magnetic or optical media, optical drive(s) or data tape(s)), a network communications adapter 150 (such as a modem, other telecommunications or cable link, wireless link, USB port, IEEE 1394 port, Ethernet card and/or port, etc.), an input means 160, such as a keyboard and/or a pointing or point-and-click device (such as a mouse, light pen, touch screen, touch pad), an output device 170, such as a video display screen and/or an audio speaker, a removable media drive 180, such as a floppy disk drive, CD drive, DVD drive, PCMIA port, CD-WORM drive or data tape drive, and a printer 190. The user or client system 40 also runs media player 100, which can be in the form of an operating system controlling the operations of the system 40 and the communications among its various components connected via bus 120 and also communications with the Internet 10 and servers and websites communicating via the Internet. It should be understood that the media player 100 can be any form of software, whether an operating system or application as discussed herein. Likewise, a “media player as used herein can be hardware running software consistent with the present invention, such as running on user system 40. Although the media player 100 is discussed herein primarily as a software component running on user system 40, it should be understood that a media player consistent with the present invention can include hardware components under the software control, or alternatively may be run over a number of computers, with software components of the media player residing in one or more of the computers. Media player software can reside in any or all of CPU 110, RAM 130, memory 140, removable media connected via removable media drive 180, or on a server accessible via a LAN or other network such as the ECN 10 via one or more network communications adapter 150. All, or portions of the media player 100 may also be loaded into the memory components, for example during operation. Exemplary transportable media implementing the client software (which may be in any form, such as source code, compiled or binary versions) include floppy disks, magnetic tape, and optical disks. In a preferred embodiment, a user system 40 is a personal computer, PDA, cell phone or other handheld device.

A computer software application embodiment of the present invention will now be described as a media player. The media player 100 can be a single user application designed to run on a user system 40, or alternatively a networked application to run on plural user systems.

In a preferred embodiment, the media player connects to a back end server over the Internet, which can be any type of content provider, such as an e-commerce system 30 or a media provider system 20. In this embodiment, the media player acts as a client application preferably combining the functionality of a media player, e-commerce client and the operating system desktop into one unique user experience.

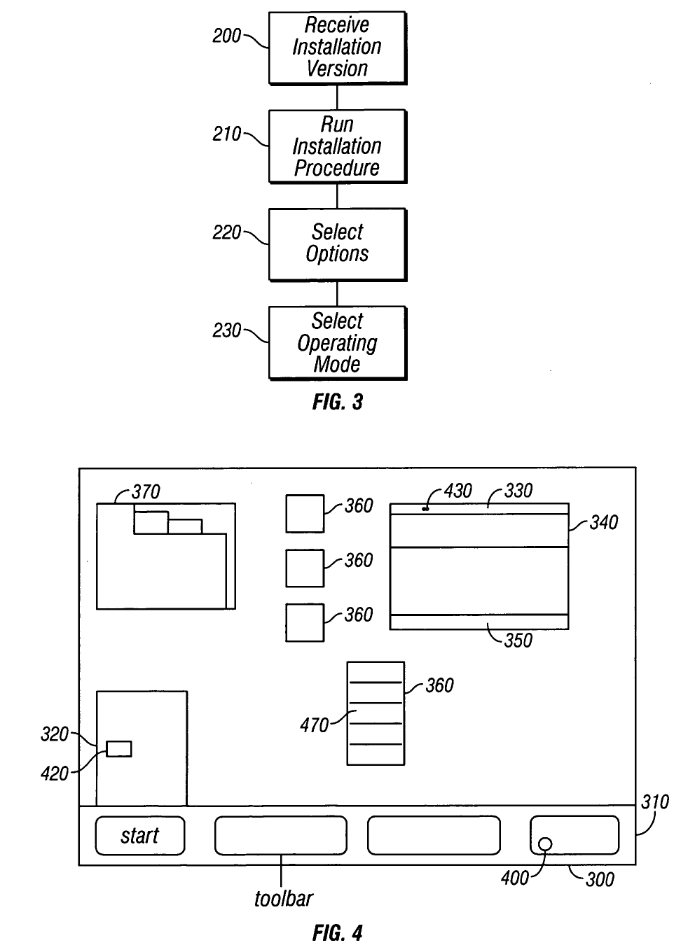

The media player 100 software is installed on a user system 40 by any desired method. In one embodiment it is pre-installed as an application or alternatively as an operating system. In another embodiment, it is downloaded from a server over the Internet. It may also be installed from a transportable media, such as a magnetic or optical media and read from a corresponding reader on the user system 40. For example, the media player can be loaded on to the user system 40 via a DVD or CD disk loaded onto a drive in a computer. The installation process installs the necessary application software on to the user system 40 personal computer. In an application program embodiment it places an icon for the application on the desktop and installs an icon into the operating system menu system. One example of an installation process is illustrated in FIG. 3. In this embodiment, the media player 100 is application software loaded on to and operating on the user system 40. In the step illustrated with reference number 200, an installable version of the media player application is received in the user system 40. The media player is installed, as illustrated in step 210. An installation program may be run, or alternatively, the media player application is received ready to run or be configured. Various set up options are selected in optional step 220. These options can be selected in a set-up or installation program, or in a first (or subsequent) running of the media player. Likewise, a user may change the media player configuration anytime thereafter by selecting Options from a Configuration menu. Alternatively of course, options are not offered on set up or installation to make installation easier.

Various operating modes of the media player 100 also may be selected. Alternatively only one operating mode may be available. The operating mode can be selected in an installation or set-up procedure as illustrated in step 230, or alternatively can be selected at any time by selecting among the operating modes available.

One operating mode is the Full Mode. In the Full Mode, the media player application runs in its own application window on user system's desktop. All or selected functions of the media player 100 are available through the application window. In the Full Mode, the User may close, minimize and resize the media player windows as desired, by procedures normally associated with such operational steps using GUI operating systems, such as Windows.

An alternate preferred embodiment of the Full Mode is an embodiment in which the user system display is split into two regions, one region reserved for the media player functionality, and the other for other forms of display, or other applications. In this embodiment, other applications preferably cannot be displayed on the region reserved for the media player. The operation of this embodiment is similar to the part-screen embodiment of a Native Desktop mode (see below), and is described in more detail in the description of the part-screen Native Desktop mode below.

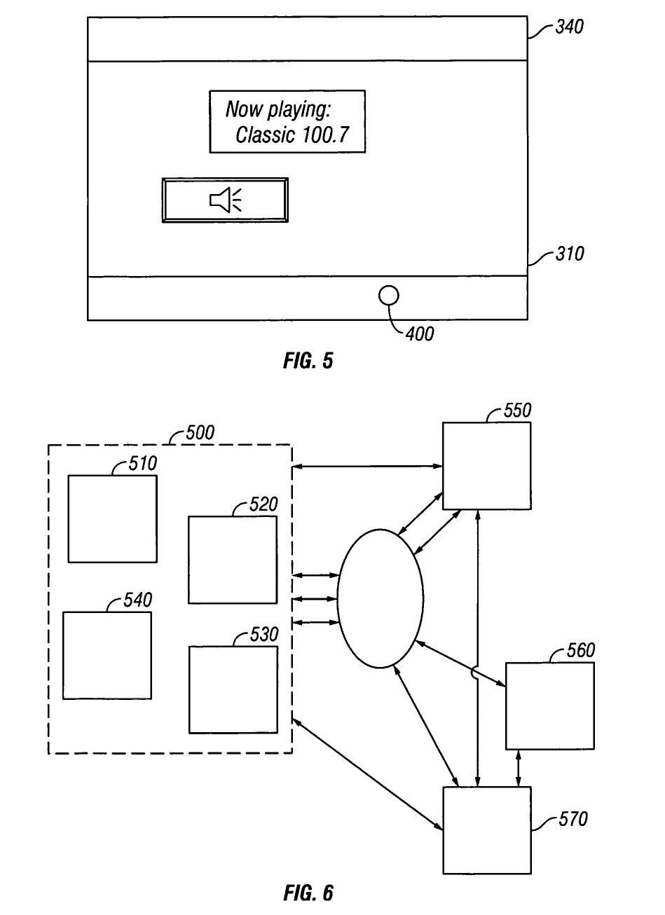

Another operating mode of the media player 100 is the Native Desktop Mode. In this mode, the media player 100 application is skinned on to the user system's desktop, i.e. controlling the system's desktop. This can involve a seamless integration into the personal computer's desktop. Various functions of the media player application (as described more fully below) may be accessible from one or more of various starting points on the user system's desktop. These starting points can include any or all of the following locations on a user's desktop: operating system tray bar 300, any other location on an operating system taskbar 310, menu system 320, such as the start menu accessed by clicking “start or a program menu, or application frame title bars 330, toolbars 340, status bars 350, desktop icons 360, pullout menu drawers 360 or dropdown menus 360 accessed from any portion of the desktop, tabs 370, scrollbars etc. By way of one example, a “radio option can be provided at any or all of the locations on a user's desktop. In an illustration, a “radio option is provided in one or more of traybar icon 400, dropdown menu 410, start menu 420 and/or frame title bar 430. In this one example, clicking on the radio selection location 400, 410, 420 or 430, a radio display is shown, such as illustrated by way of example in FIG. 5. The example illustrated in FIG. 5 is in a full screen mode, although it should be understood that a part-screen window mode also may be selected.

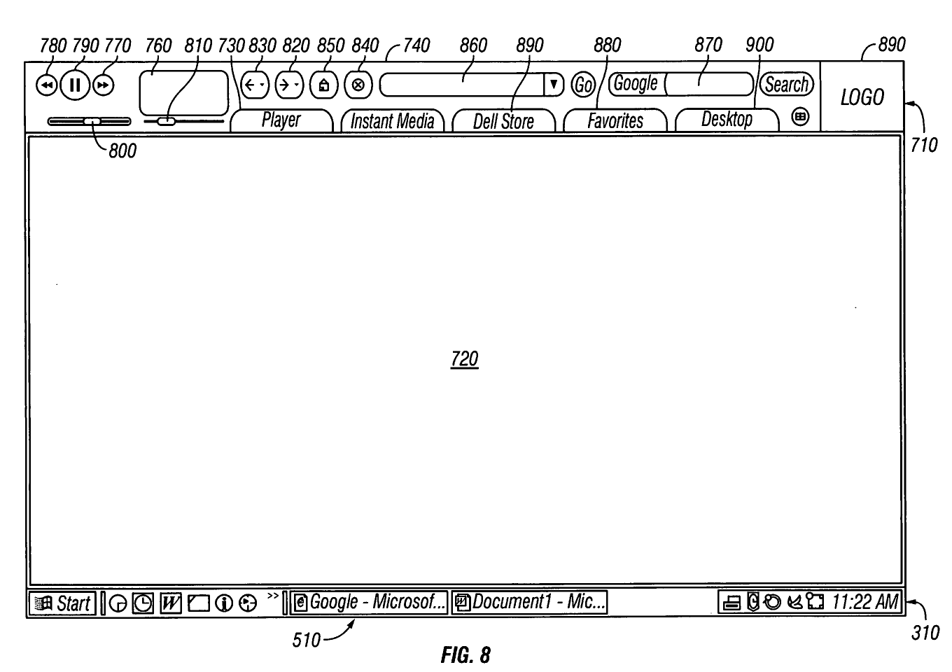

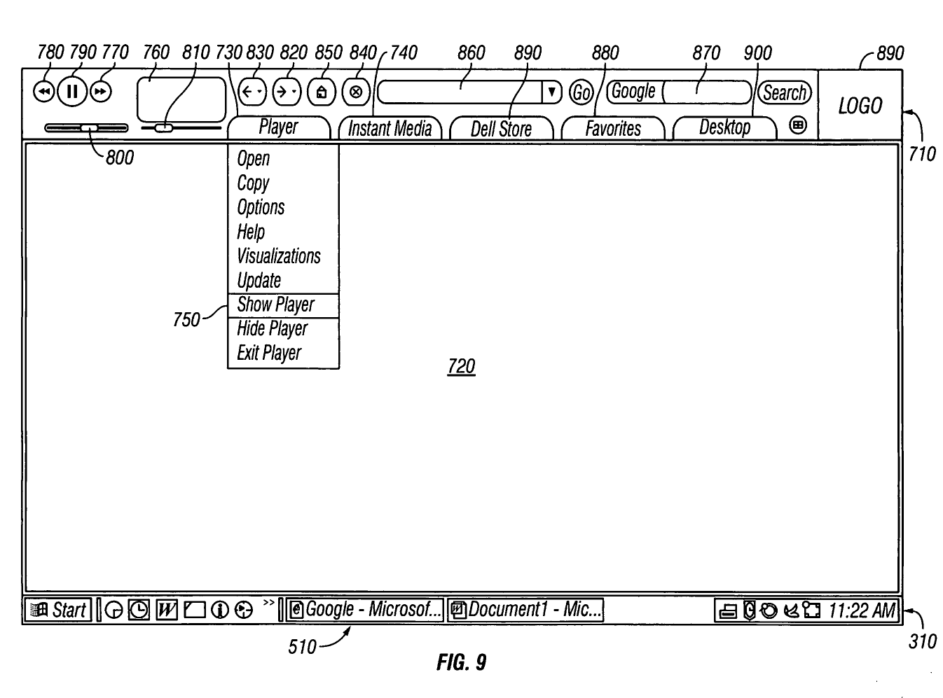

A part-screen window mode (similar to the two region version of the Full Mode described above) is illustrated in FIGS. 8 and 9. In this mode, the media player controls are gathered into a region of the user's desktop display area 510, which will be called the player region 710 or the “media player toolbar region. Thus, there are two portions of the display 510, namely the player region 710 and workspace region 720. The player region 710 is reserved for the media player 100 and the workspace 720 is the working area available to the user, although it should be understood that there can be some overlap of display, such as with menus of one region overlapping into the other, or being fully displayed in the other region. In one embodiment, the player region 710 corresponds to the toolbar region 340 illustrated at the upper side of the display area in FIG. 5 and is one embodiment of that region 340. Of course, the player region 710, can be positioned at any part of the user's display, such as top (as illustrated) bottom, a side, or other portion.

Preferably upon startup of the user's system 40 in this embodiment, media player 100 functionality access is available in region 710. One way of accomplishing this is to put start instructions in a system initialization file, or start file. Alternatively, the media player 100 in this embodiment is incorporated as a part of the operating system that starts and creates the media player region 710 as part of start up.

In a preferred embodiment, a user interface is provided that integrates a desktop (i.e. workspace region 720), Internet browser and/or search system, media player and optionally e-commerce functionality together in one desktop experience. In this embodiment, a computer 40 becomes an entertainment, media playing or Internet appliance at start up, providing instant access to Internet, searching, and media This appliance 40 can be implemented as a hardware or a software integration as discussed above. In one example of a hardware integration, the media player appliance includes computing components such as including a CPU 110, input device 160, memory 130, 140, 180, output devices such as a display 170 or speaker and network connection 150, the personal computer run by an operating system that includes the media player 100 features of this invention, or alternatively that has a separate media player 100 loaded at startup or upon user selection.

In the native desktop mode, the user may dedicate the desktop 510 or workspace region 720 to other applications such as work environment applications, but the media player functionality is easily accessible to the User. Unlike other applications the media player does not need to occupy any of the desktop 510 or workspace region 720 in one embodiment. It is embedded directly into the system environment at any desired locations.

Another operating mode is a customized desktop. This mode can incorporate the functionality of the native desktop mode or the full mode, with additional customization options. For example, a user can select (or develop on her own) a customized the look and feel, of the system desktop. The media player application is thereby embedded into the desktop skin in a customizable fashion. For example, in this embodiment, the user can select among various options for placement of links (or click locations) for various different functionalities (described below) of the media player. For example function “A can be specified for location on a traybar 300 and start menu 320 and function “B can be specified for location on a pull down menu 360 and traybar 300 and so on for as many functions as desired. In this example, any function can be function “A or function “B . In an embodiment, at least one default set up is provided that is customizable. Likewise in the customizable mode, the appearances of different parts of the desktop are customizable or “skinable , such as graphics, window appearance, frame appearance and so on. Also in the Customized Desktop mode, the user can select among the various functionalities to incorporate.

The same benefit applies in Customized Desktop mode as in Native Desktop mode. The User is able to maximize the desktop for work or other applications, yet have full access to the media player functionality as desired.

In an embodiment a user also may switch between operating modes. The Player application may transition between Full Mode and Native Desktop Mode or between Full Mode and Customized Desktop Mode, or between the different types of Full Mode, such as application window and reserved desktop space. The User may also switch between Native Desktop Mode (non-Skinned) and Custom Desktop Mode (Skinned).

Various optional functions of the media player 100 now will be described. It should be understood that all or any combination of these functions can be incorporated in the media player 100. Likewise, in a customizable desktop mode, the user optionally can select among the functions desired. As the functions are discussed, one possible embodiment will also be described with respect to the player region 710 embodiment. It should be understood that these and other functions of the invention are provided for illustrative purposes only and other features can be incorporated as well. Likewise, although some of the functions are illustrated with regards to the player region 710 embodiment, the functions also are in other embodiments of the invention as desired.

One function is integrated shopping, i.e. e-commerce. This function can enable shopping and purchase of any desired goods and services, including media related items, such as music, movies or video, or any other goods and services. The media player 100 enables e-commerce directly inside the media player, without the user needing to open a browser window or other software to visit e-commerce websites 30 or media provider websites 20. The User may shop for products and services. Software and media purchased optionally are downloaded directly to the media player and installed into the a media library of the media player (also called a “cache , “cache library or “cache memory herein). In an embodiment, the media player is fully integrated with an e-commerce engine, both of which are skinned onto the operating system desktop. In the part-screen window mode illustrated in FIGS. 8 and 9 illustrates integration of e-commerce in a number of ways. For example, clicking on player button 730 or Media button 740 brings a drop-down menu 750 (the illustrated window is displayed by clicking the button 730) having any desired options for operation of the media player. It should be understood that “button is used herein to indicate any graphical indicator for selecting a functionality, and “drop down menu is used to indicate any option selection graphical display. Other forms of menus can be used, such as for example pop-up menus, draw out menus etc. A user can purchase or manage digital rights of songs stored on computer. For example, media (such as audio, video or audio video) may be cached on the user's system 40 for optional purchase or display. The media can be pushed or pulled by the media player 100 from remote systems, such as media content systems 20 or Internet commerce systems 30. If selected by the user, a cached media file, optionally can be played, or optionally can be purchased, if purchase is required prior to playing.

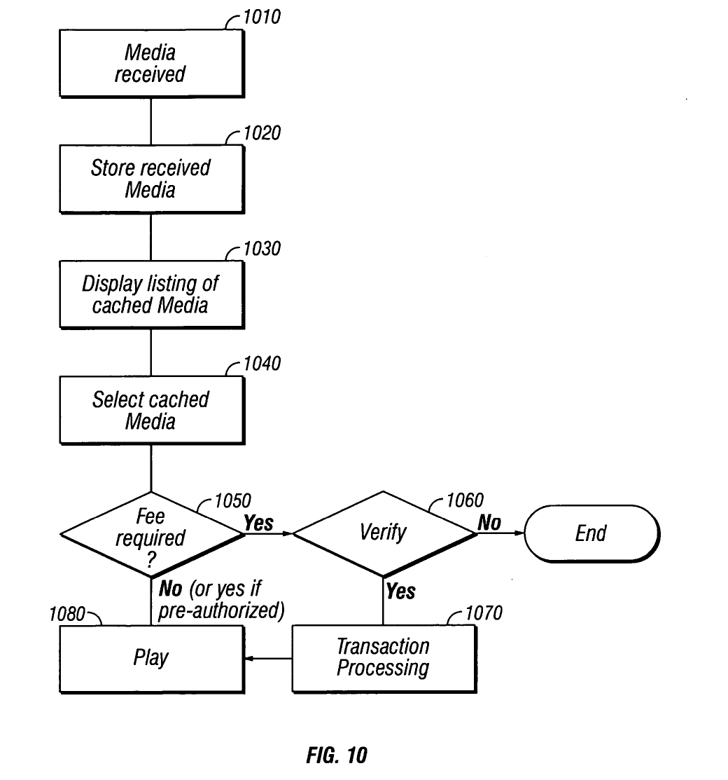

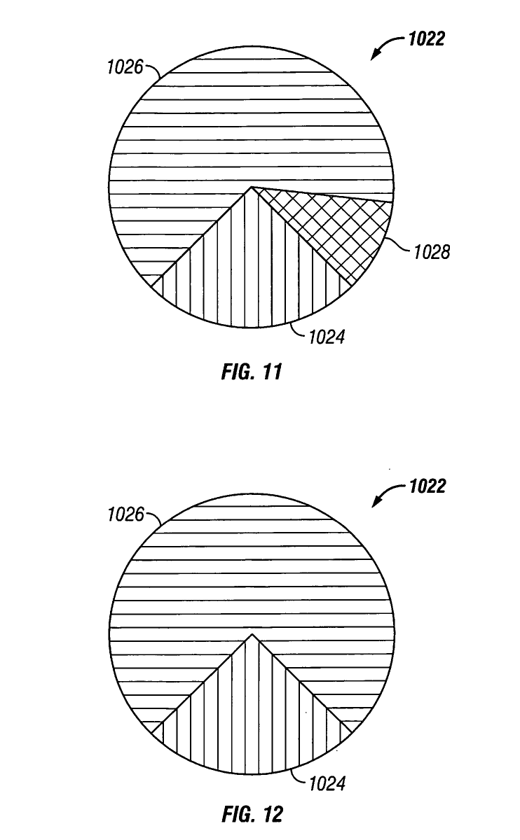

One example of storage and access to cached media is illustrated in the flowchart illustrated in FIG. 10. In step 1010, rich media (any type of data file, preferably containing audio, video or audiovideo data) is received in the user system 40. It can be received in any fashion, such as downloading as performed by the user, automatic pulling by software, such as the media player 100 software, or pushing from a remote system, such as for example systems 20 or 30 or advertising servers 1210 (discussed below). The media received in user system 40 is stored in one or more of its memory media, making it cached media, as illustrated in step 1020. The media can be stored for example in RAM 130, memory 140, removable media in drive 180 or on a networked memory such as accessed via interface 150. Optionally the user can set the desired location in a local or a remote memory. A graphical depiction of a user memory 1022 is provided in FIGS. 11 and 12. In the memory depicted in FIG. 11, the available memory space is partially occupied by the cached files. In particular, program or other data files of the user are depicted in region 1024. These may be files that come pre-installed on the computer 40, or are otherwise placed upon the computer 40 such as by CD or DVD loading, or downloading from the Internet. The cache memory is graphically depicted as region 1026. This is memory filled with data or files loaded optionally automatically using the media player 100 software or operating system. Automatic loading will be discussed in greater detail below. Unused memory area is depicted in region 1028 of FIG. 11. The memory depicted in FIG. 12 has all otherwise unused disk space occupied by the cache memory 1026.

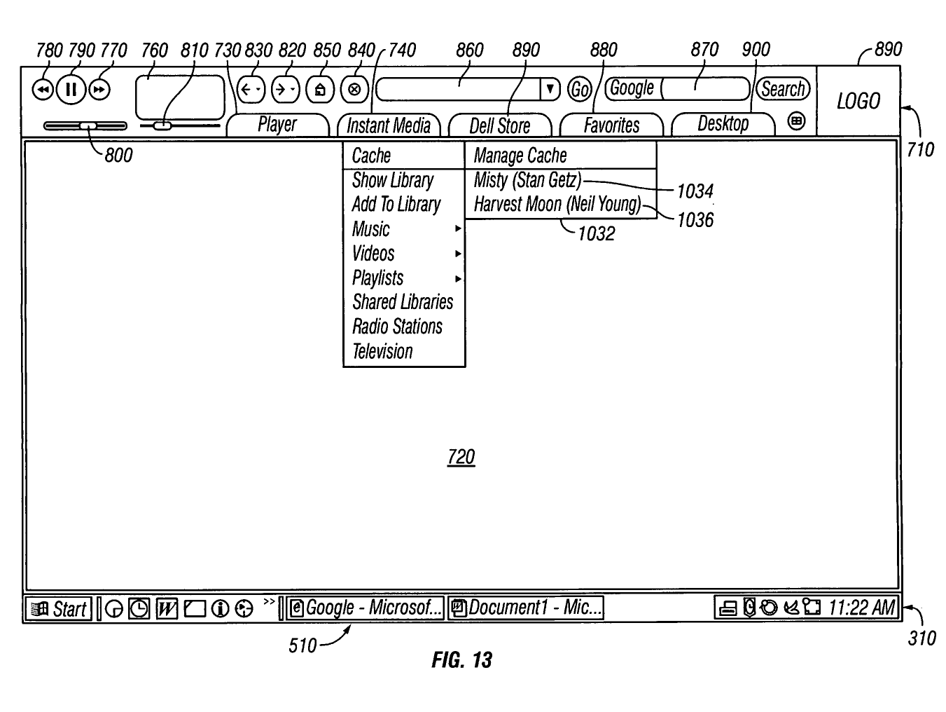

Continuing with the processing steps depicted in FIG. 10, in step 1030 a listing of cached media is displayed, such as on screen 170. This is accomplished in one embodiment by clicking on the player 730 or media 740 buttons, and selecting a cache display option from a menu. An example of such a cache listing menu 1032 is depicted in FIG. 13, with identifiers (i.e. visual representation) of two content files 1034 and 1036, shown by way of example. It should be understood that numerous more content files can be included in the cache memory listing. In addition identifiers of cached files can be located at any desired location such as in the Music, Videos, Playlists, Library locations illustrated in FIG. 13, the Visualizations location illustrated in FIG. 9, or any other categorization or sub-categorization. The cached data (files) can be listed in one or more such locations for example. Likewise they can be positioned their automatically by the or alternatively manually as desired such as by drag and drop or any other technique for positioning data identifiers.

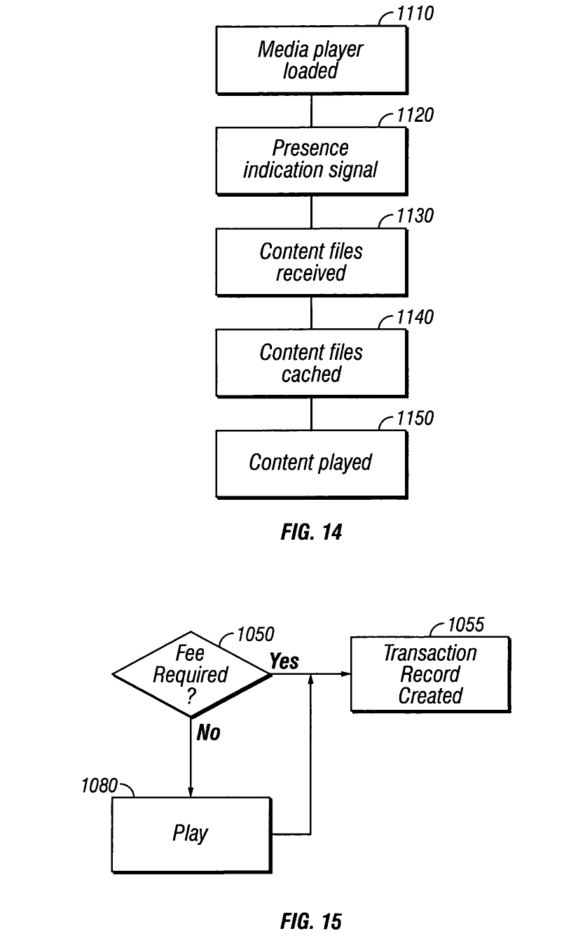

An example of loading files or data into the cache memory 1026 will be discussed from the point of view of a client system 40 is illustrated in FIG. 14. In step 1210, the system is started, with the media player 100 of the present invention operating. An Internet connection is established by the media player 100 and a presence indication signal(s) optionally is sent from the client system 1240 to one or more server 1210 as indicated in step 1220. Optionally this signal can include identifying information for the user, billing information, password information, and/or system status information. Alternatively, billing information or other information such as system status information, user demographic or prior usage information corresponding to a particular user can be pre-stored on a server. In one embodiment, the billing information (or other information) is keyed to a user identification that can become known from the identification signal, or alternatively is contained in the identification signal. The system status information may optionally include information on previous log ins, content viewed or otherwise accessed or paid for when off-line, goods purchase information concerning goods and services purchased when off-line (such as using the cache system described above or other forms of a goods purchase cache system), memory space (for example disk space) occupied by the cache 1026, or size of available memory space 1028. Based on the presence indication signal, media content to be sent to the user system is identified, and optionally a timing schedule or script particular to the user (or plural users) is created or identified for the user. For example, a central server or servers, which can be any type of server, such as servers 20, 30, may determine free content files, pay content files and advertising or offer files to be provided to the user, along with the optional timing schedule or script. Optionally, the advertising content files are played when particular free content files are selected by the user for playing.

The content cache memory 1026 can be filled with any type of content desired, such as songs, movies, advertising etc. In a preferred embodiment, all of the blank memory of user system 40 (preferably the hard drive alone) is filled with content of the cache memory 1026. The cache memory 1026 also preferably would be invisible to the user of user system 40. In other words, it would appear as empty hard drive space to the user, even though it contains content available via the media player 100. Preferably the cache memory space 1026 occupies all of the available memory space (or hard drive space) of the user system 40, in order to maximize the content available to the user on the user system 40. If user desires to enter programs or other data into the memory of user system 40, the user can do so, and preferably has priority access, and some of the cache memory space is correspondingly reduced, along with its content. Selection of the cache memory 1026 files to delete can be done on any preferably automatic scheme, such as first in first out, predetermined hierarchy, such as songs first then movies, or old songs first then old movies, or new songs first, or detected user preferences, or specified user preferences etc. Likewise, the player system 100 can replace existing cached data or files with other data or files received via the ECN by the media player.

In one embodiment, the cache file listing 1032 is color or iconically coded to differentiate among content. For example, free content, already paid for content and not yet paid for content would appear differently. Color coding is one example, such as titles of free content may be green, already paid for content black and not yet paid for content can be red. Alternatively or additionally, icons can be used such as “$ signs for content requiring a payment.

In an alternative embodiment, user systems 40 are purchased by the users with the a cache memory 1026 pre-loaded with content. Thus the new computer system comes with visible files, in the user file space 1024 and not visible files in the cache memory space 1026. This can involve any amount of content limited typically by available disk space. In one embodiment the cache 1026 comes pre-loaded with a specified number of movies, music videos, commercials, songs and or website content.

On embodiment of cache content would be website content. Thus, in this example, certain websites subscribe to a media player content supplier to provide the full content updates of their websites at specified time intervals. Subsequently, particular user systems 40 identified as targets of those websites (either by request, subscription or other determination) receive periodic loading of the website content into their cache. Thus a user who wants daily news could have a news website content cached directly to the cache 1026 overnight, and then view any time desired, such as in the morning. This has the advantage of a more robust user experience and at the same time shifting the website's bandwidth usage if desired to lower cost or volume times.

As illustrated in step 1130, the selected content files are received in the user system 40, from any desired source, preferably via the Internet 10. Optionally a play schedule or script is received by the user system 49 first, and then the user system 40 acts in accordance with the schedule or script. For example, the script can designate. times and content to download (and locations where the content can be found) to the user system 40, and the user system 40 can act accordingly. In other words, the script can include identifications of said one or more media files, location data indicating the Internet locations from which designated ones of said media files can be downloaded, downloading sequence for said one or more media files and /or a download timing parameter or any other control instructions desired for the client system. It is understood “script as used herein refers to a file or other form of data containing the desired information. The received content can either be displayed as desired, or optionally (or additionally) stored in a memory on the user system 40. This memory can be organized as the cache memory discussed above. As indicated in step 1 140, the content is played.

In one embodiment, the user system 40 is left on at all times, or at relevant times, and a presence indication signal is not provided, or is periodically provided. In this alternative embodiment, when the user system 40 is not connected to the Internet at a relevant time, content is not received. When the user system is connected to the Internet at relevant times, the cache memory is filled.

Continuing with the method illustrated in FIG. 10, the user then selects a particular media file(s), as illustrated in step 1040. The selection can be either to immediately display, or alternatively to effectuate a payment. If the media does not require a payment, the media is displayed in step 1080. Alternatively, if the content requires a payment for display (such as a fee-required song or movie), various payment techniques can be used. One is a verification system as shown in FIG. 10. The system asks for verification from the user as to whether charging a payment is acceptable, as illustrated in step 1060. If the user agrees, a transaction processing procedure 1070 is performed. Any form of transaction processing may be used in which payment is made to the media provider. In one example, the user has pre-subscribed and the payment information is on file at a media provider system. If the user accepts charging, therefore, the user is billed or credit card charged, or other payment form accomplished prior to display of the cached media. If the user declines to pay in step 1060, display processing ends. If payment is accomplished in step 1070, the media is then played in step 1080.

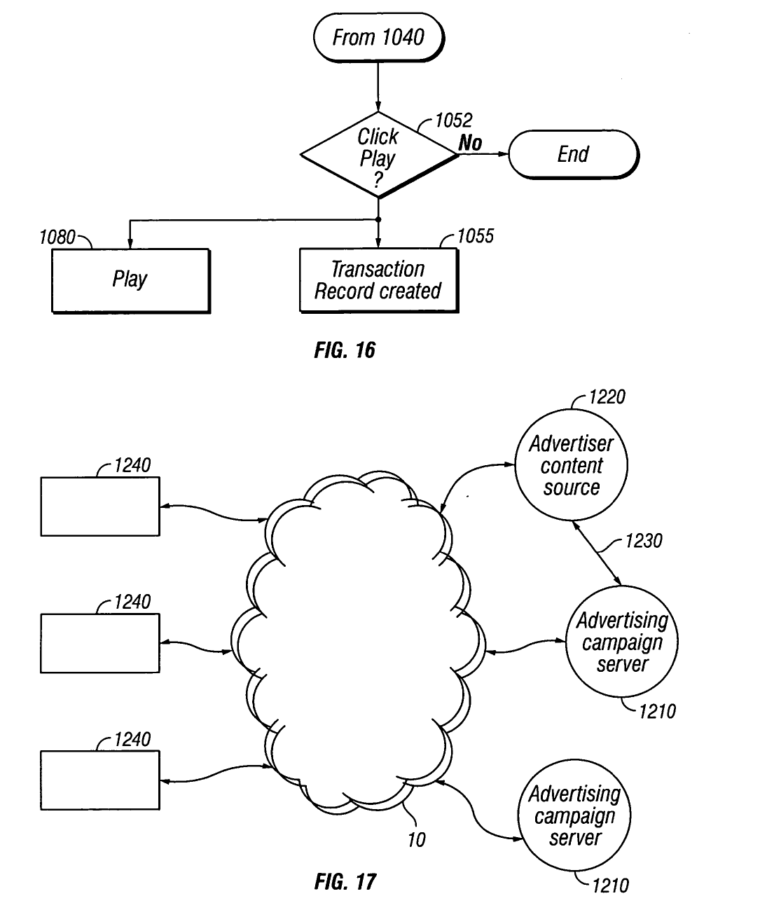

No-click payment is an alternative payment processing, as illustrated in FIGS. 15 and 16. In the embodiments depicted in both figures, a determination module determines whether a fee is required to be paid in step 1050, which corresponds to the determination conducted in step 1050 of FIG. 10, already discussed. In the no-click embodiment illustrated in FIG. 15, when fee required content is selected by the user, following the “yes line graphically illustrated, the content is then played in step 1080, with no further clicks required. A transaction record is also created. The transaction record can take any form, such as a transaction signal immediately sent to a transaction processing system or server system 20 or 30 via ECN 10, or a signal or data file stored on the user system 40 for eventual sending out. The transaction record indicates that a fee for content was viewed or selected by the user. Payment is effectuated such as via a debit account pre-created via a subscription, or via a payment processing using stored payment information (such as credit card, debit card or checking account information for the user), which preferably is in a server or subscription service. The amount of fee or an identifier of the content selected (with corresponding fee otherwise known in a payment processing system database) also preferably is in the transaction record created. In a preferred embodiment, at pre-specified times (or idle times) payment transaction information is swept to the respective remote server system and/or transaction processing system. In an alternative embodiment, the user has a subscription allowing a certain amount (or unlimited amount) of fee required content in a time period, and the amount permitted is locally stored and debited in a transaction account. When the amount paid for is exceeded the user either must subscribe for more content or wait for another subscription period, if on a periodic plan. It is noted that FIG. 15 shows the play step 1080 initiated simultaneously or in parallel with the transaction record created step 1055. Alternatively these steps can be performed in series, with the transaction record creation 1055 performed first and then the play step 1080. Less preferred would be playing 1080 followed by transaction record creation 1055. It should be noted that this type of transaction record creation and transaction processing also can be used in the transaction processing step 1070 discussed above.

An alternative of the no-click payment system is illustrated in FIG. 16. In this embodiment, step 1050 of FIGS. 10 and 15 is not performed. Instead, processing from step 1040 (selecting content) goes directly to a play selection module. In one illustration, a play dialog box appears on the user's display, with a play key (such as for example a universal play triangle symbol) is displayed. If the user clicks on the play key, the transaction record creation step 1055 and play step 1080 are performed in any order or in parallel as discussed previously. A user can close the play dialog box, such as by clicking on an “x universal close window symbol in the upper right corner of the play dialog box. In that case steps 1055 (transaction processing) and 1080 (play) are not performed.

In one embodiment, once the play button is pressed in step 1052, processing passes without delay to transaction record or processing as illustrated with step 1055. In another embodiment, there is some delay, such as a 10, 20 or 30 second or longer delay. One purpose this achieves is to allow the user system 40 time to commence laying of step 1080.

In another example, with reference to FIG. 10, if the user has pre-subscribed and pre-authorized the media provider to charge the user's account upon selection of the media the media is played in step 1080 without the verification and transaction processing steps of 1060 and 1070. In any of the payment embodiments, the payment information can be stored locally on the user's system 40 or alternatively sent immediately to a payment processor via ECN 10 (such as Internet). For example, if the user has pre-authorized the charges, but is not connected to the Internet, the media is displayed, and when the user connects to the Internet, the media player 100 transmits the charges to the transaction processing system. Likewise, the transaction processing and authorization of step 1070 can be conducted locally without an immediate remote communication.

Another function is the radio function, discussed briefly above. In this function, for example, various radio stations and streamed audio programming are provided. This can be personalized to a programmed genre or software selected genre's depending on the user's tastes as determined from prior usage of the media player by the user. Other features can be incorporated, such as song skip, pause, fast forward and so on. In the embodiment illustrated in FIGS. 8 and 9, identifying information for the radio station can optionally be displayed in area 760. It should be understood that the radio function applies equally well to display of television or other audiovisual programming as well.

As discussed in greater detail above, the User may use the media player client application 100 to stream personalized media directly to the computer desktop. The media player 100 contacts a server over the Internet and requests media. The server controls the media stream back down to the media player client. The media player client displays or plays the streamed media for the user. A subscription media function also can be provided in which certain media streams or stations require a payment for access. It should be noted that the streamed media can be any form of media, including the cached media display, as discussed above, or other forms of cached media display, such as personalized advertising.

The User may use the media player client application to specifically select media, as also discussed above. The selected media is delivered from servers over the Internet to the media player client application on the user's system 40. The media player client application displays or plays the selected media. Any player functionality can be implemented, such as starting, stopping, skipping, fast forwarding and reversing. For example, illustrated functions include fast forward button 770, reverse button 780, pause or stop button 790, volume slide bar 800 and play position slide 810.

Media on demand is another feature optionally integrated into the media player. The user selects specific media to be streamed to the media player from servers over the Internet.

Play list management is another optional function. The media player is used to manage various user created play lists as discussed above. The media player application client also optionally creates default or customized play lists such as: most popular, most recently added, genre specific, etc. or experience based.

A Digital Magazine functionality also optionally is implemented. The media player enables viewing of online digital magazines, such as BuyMagazine available at buymagazine.com. The media player implementing this functionality optionally supports e-commerce through the digital magazine.

Optionally, contextual discovery (or artificial intelligence programming) can be implemented for the media player to generate information, text, graphics, commercial offers, advertising or recommendations directly related to the currently playing media, or to media previously played.

Optionally, the server system generates the information, text, graphics, offers, advertising, recommendations, etc. based on information provided from the media player. In this option, the media player provides the server information about the currently (now) playing media or media previously played over any desired time period. The server uses this information in a software implemented process to make decisions and selections of data to send to the media player for processing and/or display. Examples of information generated can include artist biography, influencers, and contemporaries and genre information.

The media player optionally includes a media library function in which music, photos, movies and other media are managed, organized and/or displayed as discussed above. The library preferably is stored as a database either on the user's stem 40 or on a system accessed via the Internet, where the user may store media content to be played or viewed in the media player application client. The user may search and sort the contents of the media library. For example display of the media library contents optionally is in accordance with the display of cache library as discussed above.

Download management and scheduling is a further optional function as discussed above. Users may use the Player 100 application to schedule downloads of media. Likewise the user can record streamed media, or video, such as television programs. Optionally, a download storage disk space limit is set in order to prevent overloading of memory modules available to the media player. A user also can select and review automatic downloads of recommended media as determined by preferences stored on or determined by the media player 100 application or a server accessed via the Internet. The media player 100 may accept storage on behalf of the user's system 40 that is pushed to it from servers over the Internet.

One implementation of download management is of an advertising vehicle in which, in addition to possible functions discussed above, such as an entertainment system operating with cached content,. In this embodiment, advertising campaigns can be targeted as specific users as selected by any criteria. Examples of criteria are geographic, demographic, or contextual as observed from interests learned through previous use of the media player or other content access. At desired times, advertising campaigns are sent from a supplier system (such as illustrated with reference numbers 20 or 30) to desired user systems 40. They can be stored for sending to the user system 40 until the user system is available to receive the content, such as by accessing the Internet or a particular website on the Internet.

One embodiment of an advertising. display system is illustrated in FIG. 11. In this system, one or more advertising campaign servers 1210, and advertisers or advertising content sources 1220 are provided (i.e. campaign owners). It should be noted that these also are called servers 20 or 30 in this description. Optionally, the advertising campaign servers 1210 and advertiser content sources 1220 communicate with each other via the Internet 10 (or other ECN), or via direct communications link 1230 (such as wireless or telephonic). The advertisers can operate to provide the parameters of the campaign such as by providing the content, and selecting users to receive the campaign (such as by making demographic or interest based selections), set a maximum price for the campaign, select the timing and so on. In one embodiment, advertisers are make selections on criteria including optionally, time for display of the advertising content, bandwidth of the users, user demographics, user location, subscriptions selected by particular users etc. The advertising campaign server(s) 1210 then program, schedule and implement the campaign. The content preferably is provided to user systems (i.e. clients) 1240 (also called user systems 40) including the media player 100 functionality via the Internet 10 or via intermediary parties serving via the Internet. Optionally, the user systems 1240 can communicate with each other also via the Internet. Preferably the media content is timed to be sent to user systems 1240 at a low bandwidth usage time, although if a user system 1240 is not in communication with the Internet at a desired time, the media content is sent when available.

One example of operation of the advertising display system can be discussed with reference to the procedure illustrated in FIG. 14. Steps 1110, 1120, 1130, 1140 and 1150 are performed as discussed previously, one difference being that the content is advertising content.

The received advertising content can either be displayed as desired, or optionally (or additionally) stored in a memory on the user system 1240. This memory can be organized as the cache memory 1026 discussed above. As indicated in step 1150, the advertising content 5 is played. The advertising can optionally be played upon selection by the user, upon selection of another media file by the user and played in conjunction with that file, or optionally on an automatic schedule provided to the user system 1240. In one example, a content tile is a movie. Advertising content can be displayed like commercials interspersed within the move, at the beginning or end, or in a frame. In another example, a user can be offered payment options for content, such as free if viewed with advertisements, or fee if no advertisements. In a further example, content is played like a radio station or a stream of plural songs, or mixtures of songs and news or other content. Periodically, advertising is played either simultaneously, or as advertising breaks.

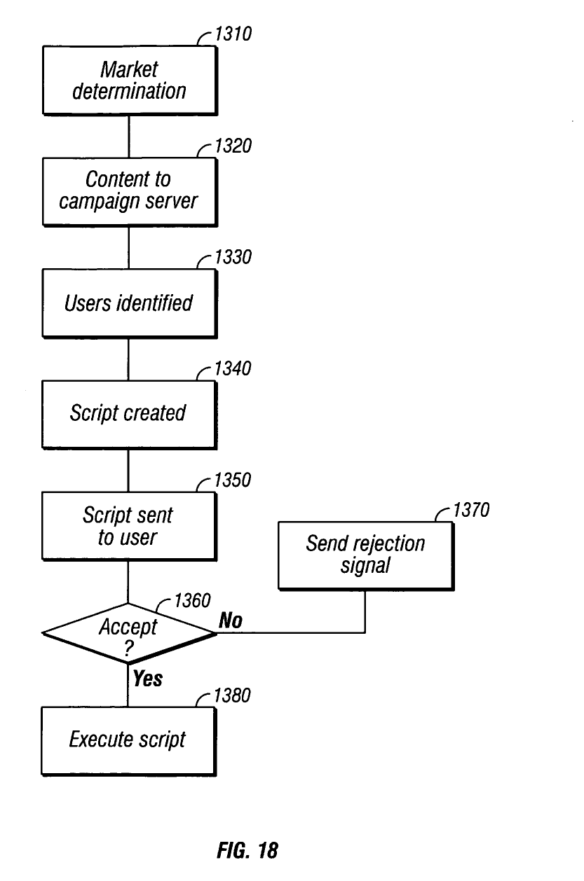

FIG. 18 summarizes an embodiment in which an advertising campaign is conducted in accordance with a script provided to the user media player system 1240. The advertiser (campaign owner) determines the target users, as discussed above, and as illustrated with reference number 1310. In step 1320, the advertiser delivers its advertising content to the advertising campaign server 1210. An example of a delivery vector is illustrated with line 1230, although the delivery can be accomplished via the Internet 10 or other ECN. Users also are identified based on the selection criteria determined in step 1310. This identification may be performed before or after step 1320 and is illustrated with reference number 1330. The users preferably are selected from a user database containing various subscription, demographic, geographic, preference and other data in accordance with the criteria determined in step 1310. Then in step 1340 a script is created for one or more of the user systems 1240. If a particular user is identified for a particular advertising campaign, the script for that user includes an instruction to the user system 1240 to access the corresponding media content. The media content can be streamed real time, or alternatively cached in the cache memory 1026.

It should be noted that plural advertising campaigns can be included in a script, as well as any other media content. Other media content can include free or subscription music or video for example. In step 1350, the script is sent to the corresponding user system 1240. For example, this sending step can be executed after or upon receipt of a presence indication signal 1220 from the user system 1240. Alternatively, it can be sent to specific IP addresses as desired. Optionally, the user is provided with an option of executing the script in step 1360. If the script is not accepted, processing stops or alternatively as illustrated with step 1370, an optional rejection signal is returned to the advertising campaign server 1210. In step 1380, the script is executed by the user media player 100 to request and retrieve (download) data such as media files in accordance with the instructions in the script.

In still another alternative embodiment, the user system 1240 actively seeks content when certain criteria are met. For example, an idle time criterion can be used, whereby when the criterion is met, the media player of user system 1240 seeks content from content providers on the Internet, such as advertising campaign server 1210, or other server systems 20, 30 etc.

It should be understood that the preferred embodiment of a PC based media player system 100 has been discussed herein as a way of illustration. Alternative embodiments also are available. For example, smart television can be controlled in the same fashion as media player systems 40 or 1240, i.e. creation of a control script then executed on the television for the display of content and advertising. Likewise a computer type system can be used, with its display going out to a television for viewing. Another application is smart billboards or signage, in which control scripts are created for particularly selected billboards, and media content and advertising displayed thereon. One embodiment is signage at ballparks in which a scoreboard or advertising display plays content and advertising. Another application is portable music players having wireless Internet connections. Alternatively a portable music player having only a wired Internet connection can be synched by connecting it to the Internet such as via a USB cable (or other wired connection) to an Internet appliance such as a smart TV, PC or TIVO, and then is synched by announcing its presence to the server, receiving a script and downloading designated content.

In another function, the media player application 100 allows users to share media files other user systems via a local network or the Internet. Optionally, a limitation on the number of sharers can be set, such as five or ten users. The media player application “listens for other media player applications running on the local network, and when detected can communicate. The media applications may communicate with each other to enable, for example, the sharing for media files and play lists. The user may specify the type of access, if any, that another media player application may have.

Other optional functions include: burning DVDs or CDs (or any other storage media) containing media files, copying to a portable player and play list burns. For example, the user can use the media player to develop play lists, which optionally are stored onto a transportable media or sent via the Internet to another user or stored in a portable player. Optionally, the media player implements digital rights management limiting the number of transfers, plays, burns etc. as set by the copyright owner or media supplier. In one example, the media player has a counter module tracking play list or item burns and a counter limit is set to cap the number of burns. A play list burn can involve creating a play list with a set of media files and then copying it to a CD (or DVD) or portable player. Once the maximum number of burns is reached, the media player implementing digital rights management will no longer allow burning of that specific play list or individual media file.

Any media type can be handled by the media player as desired. Examples include wma, wmv, mp3, aac, mpeg, avi, jpg, gif file formats, or any other file format desired.

Preferably, the media player is compliant with digital rights management standards, such as Windows Media DRM. Optionally, it supports native and 3rd party visualizations and skins.

Other optional functions include: providing browser functionality, such as Next 820, Previous 830, Stop 840, Refresh, and Home page 850 buttons; display browser in player, such as URL selection area 860, instant search capability location 870, favorites 880, enable user to show/hide song artwork such as album graphics, adjust size, and add/delete artwork; saving songs or movies in Player/Artist/Album folders for organizational purposes, such as using options available in drop down windows available by clicking the player 730 or Media 740 buttons; user feedback functions, such as rating or reviewing music and movies; music library browsing; and sound and video quality adjustments (color, volume, timbre, pitch etc.) optionally including a graphic equalizer. In addition, the media player 100 can be personalized to particular vendors or users by positioning a brand name, logo or other identifier on the toolbar space 710, such as at the location indicated with reference number 890. A user optionally can switch between toolbar mode and a desktop mode such as by clicking on a desktop button 900.

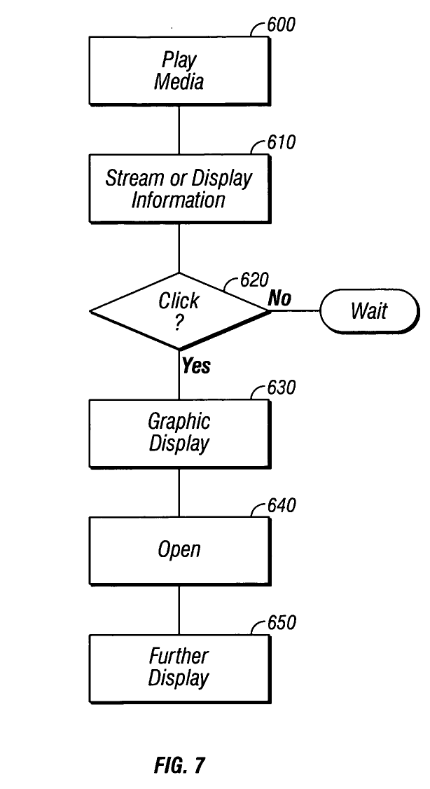

One form of Internet Commerce capability also is integrated with the media player system 100, as illustrated in FIGS. 7 and 8 for example. By clicking on the Store button 890, a drop down window is provides with any desired e-commerce options. For example, the drop down window, can provide options such as music downloads, music CD purchase, movies, electronics, photography, travel, sports, autos, etc. Upon clicking on an option, either cached information on products/services available are provided, or access to a proprietary e-commerce website is effectuated.

It should be noted that using these capabilities, the Internet, searching and music playing, for example, are available on the desktop 510 with immediate access. Hitherto, to play media content, it was required to open up a media player, like Windows Media Player form Microsoft Corp. To access the Internet, it was required to open up a browser, like Internet Explorer from Microsoft Corp. To conduct Internet searches, it was required to load a browser, then access a search site, or alternatively install a search type of toolbar on the system. These capabilities and others are provided in a seamless fashion with the player 100, whereby separate windows are not required.

Searching provides a potential revenue source for the provider of the media player 100 to the user, or for a service associated with the media player. For example, search engine services such as Google, available at google.com, Yahoo, available at yahoo.com and Overture, available at overture.com are known to generate revenues from based on some or all clicks user in search results. The media player 100 can incorporate one or more search services via search feature 870. A search produces results displayed in the workspace region 720. The user can click on links in the search results. Links that have associated advertiser fees generate revenues to the search service installed at location 870. The provider of the media player 100 also can arrange with the search services to receive a percentage of the revenue generated by its users. One example of how this is done would be by including data bits along with the click back to the search service associating the clicks with the media player provider.

One form of advertising is movie trailers or clips. For example, among the data sent to user systems 40 cache 1026 can be movie trailers or clips. The movie suppliers can pay a fee depending on the number of views, or simply a flat fee for installation on a specified desired number of user caches 1026.

A privacy policy also can be implemented whereby the player 100 supplier agrees to forego certain.types of data mining, viewing monitoring, purchase tracking etc.

A further advantage of the skinning of the present invention is that it provides a uniform user experience across operating systems. Thus a Linux controlled computer using the media player 100 will provide the same user experience as a Windows or Solaris (or other operating system) controlled computer using the media player 100.

Another embodiment of the present invention is a television type of show (providing for example a live feed, and periodically commercials selected for specific users or groups of users such as based on geography, demographics, preferences etc. are inserted into the video stream. This can be a free type of show, but in one embodiment, a user is provided an option of paying and therefore opting out of commercials. The content of the commercials can optionally be pre-cached into user systems' 40 cache memory 1026, to be played at instructed times during the television show. Thus for example, a user in one embodiment will be offered the alternative of a free streaming show, with commercials, or a subscription or unit purchase show without commercials.

Another aspect of the invention is auto-synching. In this embodiment, the media player 100 detects the build or version of the media player associated software components (or other components such as browser or subscription software). For example, version or build information can be included in the presence indication signal 1 120. Alternatively user systems 40 can periodically be polled, or periodically send out their version or build information.

A further aspect of the invention is cache hack protection methodology. In this methodology a hack detection module detects a hack attempt, i.e. to gain unauthorized access to cache memory 1026. If there is a hack detected, optionally the cache memory 1026 can be locked, partially locked (such as only fee requiring content), deleted, partially deleted (such as only fee requiring content). Also preferably already paid for fee requiring content is not deleted and remains available. In one embodiment multiple hack detection techniques are practiced in the hack detection module providing redundancy to minimize a possibility of defeating the hack protection system. In another embodiment, optionally a hack detect signal is sent out to a server system, and in turn a letter, e-mail or other notification or warning is sent to the user.

Various visual appearances, or skins also can be provided, with functionality elements being provided in different skin locations as desired. Examples of visual appearances, would be gaming skins, college logo skins, skateboarding skins, financial oriented skins, musical genre oriented skins and fashion skins.

In an embodiment as illustrated in FIG. 6, the media player 100 comprises a media player module or object 500 that can comprise any number of modules or objects corresponding to functions of the media player, as described above. Such modules or objects are diagrammatically illustrated with reference numbers 510-540. Another portion of the media player 100 is an e-commerce engine 550, which can provide access to e-commerce servers and conduct e-commerce transactions. Another portion is skinning module 560 that controls the desktop of a computer operating system 570, to position entry points into the media player 100 as desired from various portions of the computer desktop. These modules of the media player 100 and the operating system 580 are depicted diagrammatically as communicating via a central media player protocol, hierarchy or other order system 570, although it should be understood that the various components of the media player 100 can interact in any desired fashion, either directly or indirectly.

In one embodiment, a computer operating system (operating system for any microprocessor controlled device, such as a telephone) is provided in which the operating system integrates the media player and e-commerce functionality as described above with respect to the media player system and method of the present invention.

Another example of operation of the media player 100 operating in native desktop mode or custom mode is provided in FIG. 7. In this example, a user system 40 is used to play a media file, as diagrammatically illustrated in the step numbered 600. The media file can be for playing music, video etc. The player 100 optionally can stream other information, as shown in step 610. Such information can be information concerning the media being played, such as the history of the artists, other albums or movies by the artists, discography, or advertising for related media, goods or services. This streaming can optionally be provided by media player module 500, e-commerce module 550 or combinations thereof. Optionally skinning module 560 determines the location on the desktop where the information stream is displayed. The content of the information stream can come from a server system 20, 30 etc. accessed via the Internet, or from other information already stored in the user system 40. If a good or service, such as another song, movie, or electronics is offered in the stream of step 610, the user optionally can click in a desired location (or take any action indicating an option selection), as illustrated in step 620. The location can be anywhere on the desktop dictated by the media player 100, such as in the stream, on a title bar location, a button and so on. Optionally a graphic display is provided to the desktop as in step 630, to provide graphic confirmation to the user of the option selection. This graphic display can include a drawer opening, icon, pull down menu etc. The media player also opens an html component as illustrated in step 640 in order to reach to an e-commerce server 30 or media server 20 via the Internet or another network. Based on data received via step 640, the user system 40 displays information related to the good/service selected, as illustrated in step 650. Any type of information can be provided that can be perceived by the user. For examples include visual, aural, touch or even smell based information. A non-exhaustive listing of examples of such displays include: a vibration cue, playing a song or video selected, a product purchase page, a product information page, information on the titles in the album of a song being played, a download screen to purchase the song being played, information on related songs, artists, movies or other content or products that may be of interest to the user.

Thus, it is seen that a media player and operating system are provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

1. A content delivery method comprising:
identifying a plurality of clients to receive a media file;
creating a script file for one or more of said clients;
receiving one of said script files in a corresponding client media player system;
executing said script in said client media player system..

2. The content delivery method of claim 1 further comprising sending advertising content to an advertising campaign server from an advertising campaign source.

3. The content delivery method of claim 1 further comprising downloading advertising content from an Internet server location to the client media player system in accordance with said script.

4. The content delivery method of claim 1 wherein said client media player system includes a PC.

5. The content delivery method of claim 1 wherein said client media player system includes a television.

6. The content delivery method of claim 1 wherein said client media player system includes a billboard.

7. The content delivery method of claim 1 wherein said client media player system includes a portable music player.

8. A content delivery method comprising:
receiving data files in a content player system;
caching said received data files; and
displaying a listing of said cached data files.

9. The content delivery method of claim 8 further comprising selecting one or more of the cached data files.

10. The content delivery method of claim 9 further comprising determining if a fee is associated with said selected cached data files following said selecting step.

11. The content delivery method of claim 10 further comprising playing at least one of said selected cached data files that does not require a fee.

12. The content delivery method of claim 9 further comprising effectuating a payment for at least one cached data file that is determined to require a fee.

13. The content delivery method of claim 10 further comprising effectuating a payment for said at least one cached data file that is determined to require a fee.

14. The content delivery method of claim 13 further comprising generating payment or debit data indicating a selection operation for said at least one cached data files that is determined to require a payment following said effectuating payment step.

15. The content delivery method of claim 8 further comprising:
providing a visual representation of at least one of said cached data files; and
providing a visual representation of whether a fee is required.

16. A content delivery system comprising:
a script creation server creating a script corresponding to one or more particular identified media player systems; and
a first of said media player systems receiving said script and operated in accordance with a first said script.

17. The content delivery system of claim 14 further comprising a second said media player systems receiving said script creation server and operated in accordance with a second said script.

18. A script controlling a media player system containing the following control parameters:
identifications of said one or more media files;
location data indicating the Internet locations from which designated ones of said media files can be downloaded; and
downloading sequence for said one or more media files.

19. The script of claim 18 further comprising a download timing parameter.

20. A media player system comprising:
a cache memory storing a plurality of content files; and
a selection module adapted to identifying media files in the memory cache.

21. The media player system of claim 20 further comprising a payment module making a payment for content files identified by said selection module.

22. A media player system comprising:
a display unit including a media player region where media player functionality options are displayed, and a desktop region;
a media player selection button positioned in said media player region; and
browser functionality buttons situated in said media player region.

23. The media player system of claim 22 further comprising a cache access button.

24. The media player system of claim 22 wherein media files are accessible upon selection of said cache access button.

25. The media player system of claim 22 further comprising a library memory storing media files.

26. The media player system of claim 22 further comprising a cache memory storing media files.

27. The media player system of claim 26 wherein said library memory stores media files previously selected from among files in said cache memory.

28. The media player system of claim 22 further comprising a script execution module wherein the media player system is controlled in accordance with a script executed in said script execution module to download advertising content via the Internet.

29. The media player system of claim 22 further comprising a script execution module wherein the media player system is controlled in accordance with a script executed in said script execution module to download media content via the Internet.

30. The content delivery system of claim 22 wherein said client media player system includes a PC.

31. The content delivery system of claim 22 wherein said client media player system includes a television.

32. The content delivery system of claim 22 wherein said client media player system includes a billboard.

33. The content delivery system of claim 22 wherein said client media player system includes a portable music player.

34. A media player skinned onto a computer operating system.

35. The media player of claim 34 further including an integrated e-commerce system.

36. The media player of claim 34 further comprising:
a skinning module;
at least one media player functionality module; and
an e-commerce engine.

37. The media player of claim 34 wherein the e-commerce engine is a part of the media player functionality module.

38. The media player of claim 34 wherein the skinning module is a part of the media player functionality module.

39. The media player of claim 34 wherein the skinning module and e-commerce module are part of the media player functionality module.

40. A computer operating system incorporating media player functionality.

41. The computer operating system of claim 40 further comprising e-commerce functionality.

42. The computer operating system of claim 40 further comprising instant searching functionality.

43. The computer operating system of claim 40 further comprising browser functionality not requiring opening a separate browser window.

44. The computer operating system of claim 40 further comprising searching functionality not requiring opening a separate window.

45. The computer operating system of claim 40 further providing instant access to media files stored in a cached memory.

46. The computer operating system of claim 40 further comprising no-click payment functionality.

47. The computer operating system of claim 40 further comprising cache memory maintenance functionality wherein data files in said cached memory are loaded at designated times from a remote source.

48. The computer operating system of claim 40 further comprising cache memory maintenance functionality wherein data files in said cached memory requiring a payment for operation are denoted as requiring payment in a designated display area.

49. The computer operating system of claim 40 further comprising:
a desktop interface module;
a media player module; and
an e-commerce module.

50. An Internet transaction method comprising:
identifying media files requiring payment for playing;
selecting an alphanumeric identifier on a display corresponding to a particular media file; and
recording a transaction record.

51. The transaction method of claim 50 wherein said recording a transaction record is initiated following said selecting step.

52. The transaction method of claim 50 further comprising transmitting said transaction record to a remote server

53. The transaction method of claim 50 further comprising:
playing said particular media file; and
sending said transaction record to a remote server after said playing begins.

54. The transaction method of claim 50 further comprising: playing said particular media file; and
sending said transaction record to a remote server in parallel with playing said particular media file.

55. The transaction method of claim 50 further comprising:
playing said particular media file; and
sending said transaction record to a remote server at the same time as playing said particular media file.

56. The transaction method of claim 50 further comprising:
playing said particular media file; and
sending said transaction record to a remote server after playing said particular media. file.

57. A content delivery method comprising:
receiving data files in a content player system;
caching said received data files; and
categorizing said data files in one or more categories.
